(19) United States
(12) Patent Application Publication
(10) Pub. No.: US 2015/0268469 A1
(43) Pub. Date: Sep. 24, 2015

(54) SYSTEMS AND METHODS FOR PROVIDING INTERACTIVE PRODUCTION ILLUSTRATION INFORMATION

(71) Applicant: The Boeing Company, Chicago, IL (US)

(72) Inventors: Bobby J. Marsh, Lake Stevens, WA (US); Kinson D. Vanscotter, Stanwood, WA (US); Adam R. Richardson, Seattle, WA (US); Douglas V. Dorsey, Hansville, WA (US); R.C. Richard M. Coleman, Chicago, IL (US); Steven L. Martin, Everett, WA (US); David J. Hengy, Bothell, WA (US); Leonard S. Bodziony, Seattle, WA (US); Michael M. Vander Wel, Lynnwood, WA (US); Donald V. Heckendorf, Mukilteo, WA (US); Larry C. Jasper, Marysville, WA (US); Mark Wallis, Lake Stevens, WA (US); Chieu Duong, Everett, WA (US); Travis J. Huffine, Clinton, WA (US)

(73) Assignee: The Boeing Company, Chicago, IL (US)

(21) Appl. No.: 14/102,102

(22) Filed: Dec. 10, 2013

(51) Int. Cl. G02B 27/01

(52) U.S. Cl. CPC G02B 27/017

(57) ABSTRACT

Systems and methods for providing interactive production illustration information are provided. One system includes a machine vision system configured to attach to a user, wherein the machine vision system when attached to the user is aligned with a line of sight of the user towards a physical location. The machine vision system controllable by the user and configured to acquire an image of an article. The system also includes an interactive production illustration system coupled to the machine vision system, wherein the interactive production illustration system has stored therein interactive production illustration. The interactive production illustration system is configured to select interactive production illustration information for an assembly process for the article at the physical location based at least in part on the acquired image. The interactive production illustration information is further configured to communicate the selected interactive production illustration information to the machine vision system for display.

### BACKGROUND

The present disclosure relates generally to systems and methods for providing information for production and/or assembly processes.

Some assembly processes can be very complex and require considerable time and effort to complete. In the assembly processes the number of steps for one or more of the production or assembly sequences can be very large. As a result, it may be difficult for individuals, particularly inexperienced individuals, to efficiently perform the steps and in the proper order. Moreover, in some instances, one or more steps may not be performed, may be performed out of order, or may be performed incorrectly, resulting in delay because of the time to uninstall and then re-perform the steps. Moreover, when assembling an aircraft, there is often work performed out of position or sequence, which requires rework as a result of the out of normal assembly sequence assembly process.

Systems are known for storing instructional information that may be used to facilitate the assembly processes. For example, some systems store information relating to different assembly processes that can be accessed. However, it is difficult to store and access this information, adding time and cost to the overall assembly process. As an example, certain aircraft models are assembled at a number of different locations. Generally, fabrication processes are developed at one location, and those processes are then implemented at the other assembly locations. However, due to the level of detail that is prevalent in the aircraft fabrication industry, implementation of processes developed at a “master” location, are not always easily implemented at the other fabrication locations including difficulty in accessing the information for use in the processes (e.g., guidance for performing one or more of the fabrication or assembly processes). Thus, efficient and effective training methods and dissemination of information can facilitate the assembly process by allowing individuals to be better educated and prepared.

Moreover, because aircraft fabrication processes include many nuances, learned by final assembly and delivery (FAD) tool engineers, that have developed a FAD process for fabrication and/or installation of a specific aircraft or aircraft component, it is important to be able to quickly and efficiently access information relating to the aircraft fabrication processes during fabrication or assembly, which may be at different physical locations. However, some known systems for distributing the information and/or accessing the information are inefficient and costly.

### SUMMARY

In accordance with one embodiment, a system is provided that includes a machine vision system configured to attach to a user, wherein the machine vision system when attached to the user is aligned with a line of sight of the user towards a physical location. The machine vision system controllable by the user and configured to acquire an image of an article at the physical location based on a physical action of the user. The system also includes an interactive production illustration system commutatively coupled to the machine vision system, wherein the interactive production illustration system has stored therein interactive production illustration information accessible by the machine vision system. The interactive production illustration system is configured to select interactive production illustration information for an assembly process for the article at the physical location based at least in part on the acquired image. The interactive production illustration information is further configured to communicate the selected interactive production illustration information to the machine vision system for display.

In accordance with another embodiment, a method for accessing, by a user, an assembly sequence for an article is provided. The method includes disposing a machine vision system on a portion of the user, wherein the machine vision system aligns with a line of sight of the user, and directing by the user, the line of sight towards a physical location of the article associated with the assembly sequence. The method also includes causing, via at least one physical action by the user, the machine vision system to acquire an image and thereby generate image data associated with the physical location. The method further includes accessing, based at least in part on the image data, interactive production illustration information, wherein the interactive production illustration information is associated with the assembly sequence for the article for the physical location. The method additionally includes displaying the interactive production illustration information to the user.

The features and functions discussed herein can be achieved independently in various embodiments or may be combined in yet other embodiments, further details of which can be seen with reference to the following description and drawings.

### BRIEF DESCRIPTION OF THE DRAWINGS

FIG. 1 is a schematic block illustration of a system in accordance with one embodiment.

FIG. 2 is an illustration of a flow process in accordance one embodiment.

FIGS. 3-6 are illustrations of user interfaces displayable as screens in accordance with various embodiments.

FIG. 7 is an illustration of video content displayable in accordance with various embodiments.

FIGS. 8-13 are illustrations of user interfaces displayable as screens in accordance with various embodiments.

FIG. 14 is an illustration of operations for providing interactive production illustration information in accordance with one embodiment.

FIG. 15 is an illustration of an aircraft that may be assembled in accordance with one embodiment.

FIG. 16 is an illustration of an aircraft manufacturing and service method in accordance with an embodiment.

FIG. 17 is an illustration of an aircraft in which an embodiment may be implemented

### DETAILED DESCRIPTION

The following detailed description of certain embodiments will be better understood when read in conjunction with the appended drawings. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. The modules or units shown in the attached figures may represent the hardware that operates based on software or hardwired instructions, the software that directs hardware to perform the operations, or a combination thereof.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments described and/or illustrated herein provide methods and systems for interactive production illustration, guidance, and archiving. It should be noted that although various embodiments are described in connection with an aircraft application and/or a particular aircraft assembly process, the various embodiments may be used in connection with different applications and for different assembly processes. For example, the various embodiments may be used in land, air, sea and space applications.

In particular, various embodiments provide systems and methods to communicate interactive production illustration information for different processes, such as fabrication or assembly processes. By practicing one or more embodiments, out of position final assembly rework may be reduced or eliminated and/or production flow efficiency may be increased. Systems and methods described herein facilitate the creation of adjustable and adaptable manufacturing plans, such as by aircraft assembly teams. For example, an interactive production illustration guide may be provided that facilitates a demonstration of a large and complex assembly (or a portion thereof), such as of main landing gear doors and the connecting surrounding structure. In some embodiments, novice or new individuals (e.g., new employees) may use one or more embodiments to access an easy to navigate series of connecting graphics and videos. For example, one or more embodiments provide a simplified assembly communication tool that allows for quick common sense access, such as to production and assembly sequences defining data banks. In some embodiments, a machine vision system may be used to help view and guide the user, as well as record the actions of the user (e.g., assembly steps performed), which then may be archived and stored (optionally with additional information, such as date/time performed, etc.), for example, as a quality assurance (QA) measure.

One or more embodiments provide a production and assembly package with live graphic support, and which may be used, for example, as a back-up to a regular production flow camera, such as to the point of assembly (and disassembly) that the individual (e.g., mechanic) needs to view. Thus, re-assembly time can be reduced. In some embodiments, three-dimensional (3D) graphic aircraft assembly simulation solutions that are based in virtual and augmented reality may be used and that can interface with and leverage the existing systems to provide improved training and production environments. Thus, the integration in various embodiments will allow for a continuum of delivery mechanisms for the interactive production illustration, such as ranging from desktop, to tablet, to wearable computing devices that can be used in multiple venues. For example, various embodiments may be used in combination with teaching systems, such as described in U.S. Patent Application Publication No. 2012/0196254, entitled “Methods and Systems for Concurrent Teaching of Assembly Processes at Disparate Locations”, which is incorporated by reference herein in its entirety.

Thus, information, such as from aircraft assembly knowledge teachers, may be disseminated to multiple different physical locations, such as across a country or internationally. For example, using a machine vision system aligned with the line of sight of a user that is directed towards a physical location of an article associated with an assembly sequence, one or more actions (e.g., physical actions) by the user causes the machine vision system to acquire an image associated with the physical location (e.g., generate image data associated with the physical location). Various embodiments then access, based at least in part on the image associated with the physical location, one or more interactive production illustrations, for example, video data from a database related to a production guide (e.g., video data associated with an assembly sequence for the article for the physical location). Additionally, various embodiments then display the one or more interactive production illustrations (e.g., one or more videos) to the user, and which may be interactively viewed.

Thus, using the one or more interactive production illustrations, an individual working on a portion of a production or assembly process may view, for example, video and/or audio, that guides the individual with respect to the steps for the one or more interactive production illustrations, such as the steps for the proper assembly sequence for the main landing gear doors of an aircraft or a passenger door rigging.

In various embodiments, the machine vision system may be head mounted, such as a helmet mounted camera with a helmet mounted flip down LCD monitor that allows interactive access and viewing of information. In some embodiments, the monitor is a split screen monitor so that the user can view both the field view and the view from one of the helmet mounted cameras. Utilizing the interactive (and optionally hands-free) selection of the interactive production illustrations, allows for quick and simple to execute real time assembly techniques, such as the steps to be performed. Additionally, the physical actions performed by the individual likewise may be recorded.

Various embodiments provide a system 20 as illustrated in FIG. 1 allowing a user 22 access to an interactive production illustration system 24, for example, to obtain and view assembly techniques or sequences as described in more detail herein. The user 22 may be located at a production facility 26 and working on assembling an article (e.g., a portion of an aircraft) within the production facility. In some embodiments, the production facility 26 is an aircraft production facility. A machine vision system 30 is coupled with the user 22 and in the illustrated embodiment provides access to the interactive production illustration system 24. For example, in various embodiments, the interactive production illustration system 24 is located physically separate from the production facility 26, such as located in a separate building or in a geographically different location within the country. However, in some embodiments, the interactive production illustration system 24 may be located within or in close proximity to the production facility 26.

In various embodiments, the machine vision system 30 is configured to provide wireless communication with the interactive production illustration system 24. It should be noted that the wireless communication may be provided using different known communication schemes and standards in the art (e.g., Wi-Fi, cellular, or Bluetooth among others). Thus, the machine vision system 30 provides communicative coupling to the interactive production illustration system 24. The communication method used may be determined or changed, for example, based on the type of information to be communicated to and from the interactive production illustration system 24.

The machine vision system 30 may be any suitable device such as may be worn by the user, for example, in a helmet configuration or as interactive glasses (e.g., wearable device having Google Glass). However, it should be appreciated that the machine vision system 30 may be embodied as or include or interface with a hand carried or portable device, such as a tablet type device or portable/laptop computer. It also should be noted that in various embodiments the machine vision system 30 also includes an image recording device 32 (e.g., a camera or video recording device) that forms part of or is mounted with the machine vision system 30. The image recording device 32 is configured to acquire images (e.g., still or video images) of the article 28 and/or the surrounding components (or environment). For example, the image recording device 32 may be mounted or aligned with the user 22 to provide line of sight visualization. The image recording device 32 in some embodiments also includes memory or storage capabilities to store acquired images, for example, temporarily until communicated to the interactive production illustration system 24.

In the illustrated embodiment, the interactive production illustration system 24 includes a computing system 34 (which may include a logic subsystem 42) and a storage subsystem 36 operatively coupled to the computing system 34. It should be noted that in some embodiments, the interactive production illustration system 24 may be embodied as the computing system 34. Additional components may be provided to the interactive production illustration system 24, such as one or more user input devices 38, and/or a display subsystem 40. The interactive production illustration system 24 may optionally include components not shown in FIG. 1, and/or some components shown in FIG. 1 may be peripheral components that do not form part of or are not integrated into the computing system 34.

The logic subsystem 42 may include one or more physical devices configured to execute one or more instructions. For example, the logic subsystem 42 may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem 42 may include one or more processors and/or computing devices that are configured to execute software instructions. Additionally or alternatively, the logic subsystem 42 may include one or more hardware or firmware logic machines configured to execute hardware or firmware instructions. The logic subsystem 42 may optionally include individual components that are distributed throughout two or more devices, which may be remotely located in some embodiments.

The storage subsystem 36 may include one or more physical devices (that may include one or more memory areas) configured to store or hold data (e.g., video data or database of information associated with an assembly sequence or recorded video from an assembly sequence performed by the user 22) and/or instructions executable by the logic subsystem 42 to implement one or more processes or methods described herein. When such processes and/or methods are implemented, the state of the storage subsystem 36 may be transformed (e.g., to store different data or change the stored data). The storage subsystem 36 may include, for example, removable media and/or integrated/built-in devices. The storage subsystem 36 also may include, for example, other devices, such as optical memory devices, semiconductor memory devices (e.g., RAM, EEPROM, flash, etc.), and/or magnetic memory devices, among others. The storage subsystem 36 may include devices with one or more of the following operating characteristics: volatile, nonvolatile, dynamic, static, read/write, read-only, random access, sequential access, location addressable, file addressable, and content addressable. In some embodiments, the logic subsystem 42 and the storage subsystem 36 may be integrated into one or more common devices, such as an application specific integrated circuit or a system on a chip. Thus, the storage subsystem 36 may be provided in the form of computer-readable removable media in some embodiments, which may be used to store and/or transfer data and/or instructions executable to implement the various embodiments described herein, including the processes and methods.

In various embodiments, the one or more user input devices 38 may include, for example, a keyboard, mouse, or trackball, among others. However, it should be appreciated that that other user input devices 38, such as other external user input devices or peripheral devices as known in the art may be used. Thus, a user is also able to interface or interact with the interactive production illustration system 24 using the one or more of the input devices 38 or with the machine vision system 30.

Additionally, in various embodiments, the display subsystem 40 (e.g., a monitor) may be provided to display information or data (e.g., images as acquired by the machine vision system 30 or data stored in the storage sub-system 36) as described herein. For example, the display subsystem 36 may be used to present a visual representation of data stored by the storage subsystem 36. In operation, the processes and/or methods described herein change the data stored by the storage subsystem 36, and thus transform the state of the storage subsystem 36, the state of display subsystem 40 may likewise be transformed to visually represent changes in the underlying data. The display subsystem 40 may include one or more display devices and may be combined with logic subsystem 42 and/or the storage subsystem 36, such as in a common housing, or such display devices may be separate or external peripheral display devices.

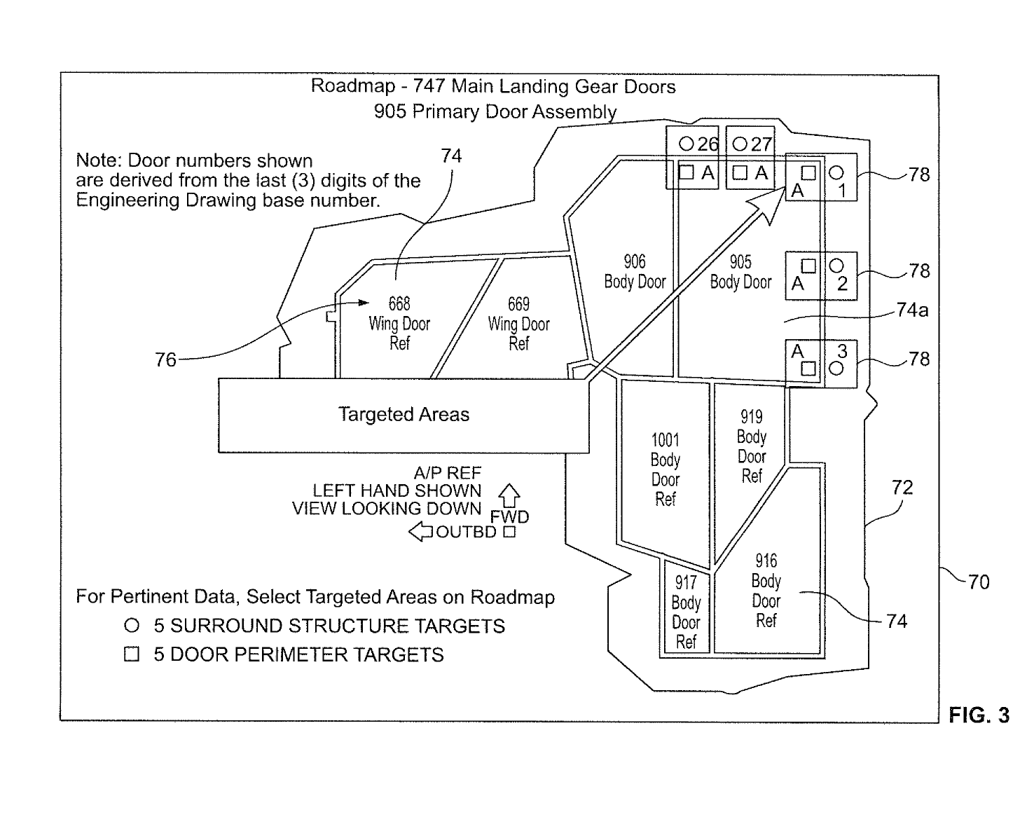

Thus, the various components, sub-systems, or modules of the interactive production illustration system 24 may be implemented in hardware, software, or a combination thereof, as described in more detail herein. Additionally, the processes, methods, and/or algorithms described herein may be performed using one or more processors, processing machines or processing circuitry to implement one or more methods described herein (such as illustrated in FIG. 3).

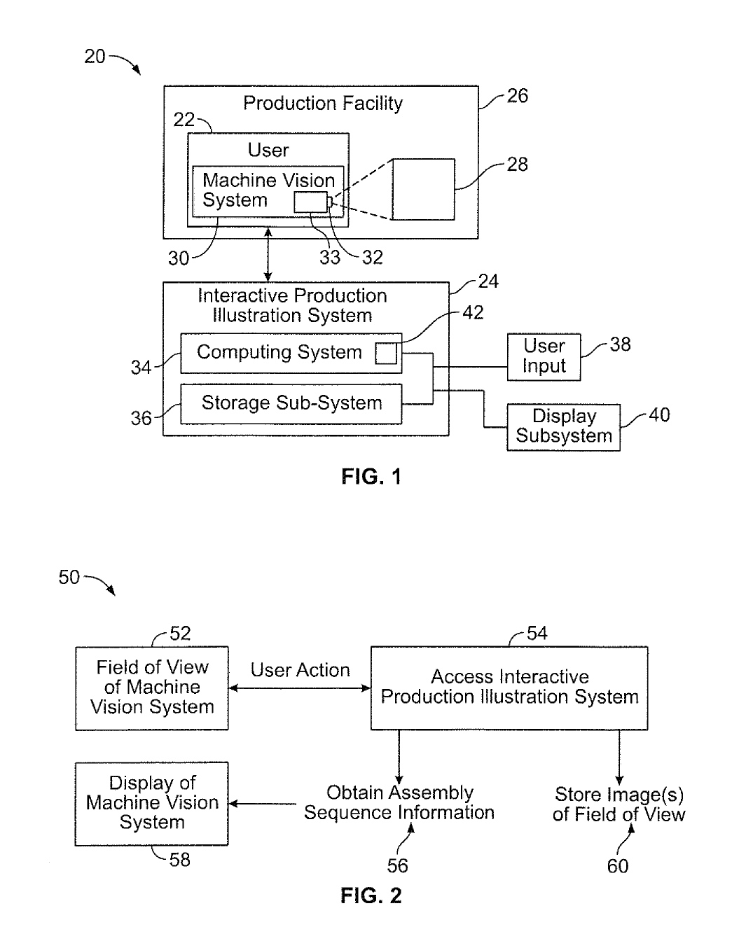

In various embodiments, different input data, such as images from the machine vision system 30 or actions (or gestures) or the user 22 may be used by the logic subsystem 42 of the interactive production illustration system 24 to select content or data to communicate to the user 22 for display at the machine vision system 30. For example, FIG. 2 illustrates a flow process 50 in accordance with one embodiment, which may facilitate an assembly procedure or process being performed by the user 22, as well as recording all or a portion of the procedure or process. In particular, and with reference also to FIG. 1, the flow process 50 includes acquiring information from a field of view 52 of the machine vision system 30. For example, the image recording device 32 may acquire one or more images (in some embodiments video) of a field of view of the machine vision system 30, which is various embodiments corresponds or correlates to a line of sight of the user 22. For example, with the machine vision system 30 mounted or attached to the user 22, such as the user's head, the line of sight of the user 22 is aligned with the line of sight of the image recording device 32. It should be noted that the image recording device 32 may be continuously recording in some embodiments (e.g., continuous video stream), but only periodically recording in other embodiments or at other times (e.g., acquiring still images at defined intervals).

The line of sight of the user 22 may be directed, for example, to an area of an aircraft that the user 22 is working on, such as in assembly process. The user 22 may desire or need additional information in order to complete or properly perform the assembly process. In such instances, a physical action of the user 22 (e.g., pressing a button on the machine vision system 30, performing some movement of the user's head or eyes, etc.) causes the machine vision system 30 to acquire an image of the area of interest and/or access at 54 the interactive production illustration system 24. For example, different defined actions of the user 22 may correspond to control commands for accessing images and/or controlling the interactive production illustration system 24, such as to access a menu of options, a database of information regarding assembly, etc. It should be noted that in some embodiments, the logic subsystem 42 analyzes the images acquired by the machine vision system 30 to determine a sub-set of data (e.g., a particular database) to access related to the object or area being worked on by the user 22 and as viewed by the machine vision system 30. For example, the logic subsystem 42 may identify some markings (e.g., ID tag or number) on a surface viewed by the machine vision system 30 or perform an object or shape matching to identify objects within the images being viewed (e.g., images of a landing gear door identified by the size/shape of door or other indicia). In some embodiments, supplemental information may be used and communicated, such as RFD or GPS information to facilitate identifying the area of interest or when storing the images.

In some embodiments, for example, quality assurance can confirm, for example, that the require bolt torque readings from a “measurement confirmation” from the desk of the quality assurance individual. In some embodiments, a required quality assurance verification is video recorded, giving the quality assurance representative the opportunity to “buy off” the current installation plan assembly requirements, from their respective desks. Thus, in some embodiments, there is no need for the quality assurance representative to walk out to the factory floor and witness the critical bolt attachment torque readings on the mechanics torque wrench. In some embodiments, for example, all critical aircraft assembly of flight surfaces and landing gear support structures installations are recorded and confirmed by quality assurance to be assembled to the required design engineering specifications. In some embodiments, this video assembly record may then be stored within a “just created” FAA quality assurance and verification “Aircraft Assembly Record” vault (e.g., in memory or a database).

In some embodiments, as a result of the user action, different types of information may be acquired as described herein. As an example, upon accessing the interactive production illustration system 24, a user 22 may be able to view a number of element or object descriptions related to the object to be assembled and select one or more item (which may include videos) for viewing. For example, in illustrated embodiment, assembly sequence information 56 is acquired (e.g., video data associated with the assembly sequence) and communicated to the machine vision system 30. In one embodiment, the information is displayed on a display of the machine vision system 30 at 58. A user 22 may be able to then view and control the display of the video using video control procedures as described herein. Additionally, it should be noted that the images acquired by the machine vision system 30 and communicated to the interactive production illustration system 24 also may be stored at 60, such as in the storage sub-system 36. Thus, in the illustrated embodiment, a user is able to access information for an assembly sequence that is easily displayed and that facilitates the assembly process. Additionally, as the user 22 is performing the assembly sequence, the machine vision system 30 may capture images that are stored, which may be used, for example, for later confirmation of the proper assembly steps, such as part of a QA process or audit.

Thus, information, such as interactive production illustrations, for example, assembly sequence information and videos (e.g., video feeds) may be communicated to the user 22 (in real-time) from a remote location in various embodiments. For example, interactive production illustration information that may include one or more videos are accessible on-site by a user 22, for example, the user 22 may view the interactive production illustrations concurrent with performing one or more assembly sequence or steps. It should be noted that in some embodiments, audio information (such as via headphones (not shown) of the machine vision system 30) may be provided in combination with the interactive production illustrations.

Accordingly, for example, a video feed may include displaying video content on a user-mounted monitor 33 mounted in the line of sight of the user 22 that is part of the machine vision system 30. For example, the user-mounted monitor may include, but is not limited to, a user mounted monitor that utilizes monocular vision enhancement, such as a flip down split screen LCD monitor mounted to headwear worn by the user 22. Thus, various embodiments allow the user 22 to obtain information on-site via, for example, a helmet mounted monitor and audio system, which may include different means to facilitate accessing and viewing the information as described herein. It should be noted that different users 22 at the same or different location may be able to access and view the same or different content from the interactive production illustration system 24. Also, in some embodiments, a number of users 22 may communicate with each other using respective machine vision systems 30. In various embodiments, reduced time for MRB action may be provided (e.g., same day action) by providing one or more images from the machine vision system 30 (e.g., investigate and determine whether a particular bolt that is not available may be replaced by a different available bolt).

Different configurations and modes of operation are contemplated. For example, split screen LCD monitors and switching capabilities may be provided as part of the machine vision system 30 that allows the user 22, for example, to select to view two views or different types of information or images.

In operation, the user 22 is able to access interactive production illustrations and acquire information (e.g., video) guiding the user 22 through the assembly steps, while also allowing recording of the actual steps performed by the user 22. It should be noted that although various embodiments describe physical actions to perform different controls, other actions may be used, such as through verbal commands, via word recognition software, to facilitate hands-free functionality. For example, different final assembly production lines may be separated by significant distances and each having different users 22 performing the same or different assembly processes. Various embodiments allow access to and viewing of, for example, assembly instructions provided in real time audio and/or video, from a first location (e.g., a central server having the interactive production illustration system 24) to the users 22 in disparate locations. Also, the users 22 in the different locations may be able to communicate with one another using respective machine vision systems 30, such as to ask questions or provide on the ground guidance (e.g., collaborative solutions).

An example related to the assembly of the main landing gear doors and surrounding structure of an aircraft will now be described. However, as should be appreciated, the various embodiments may be used in connection with different processes for an aircraft, as well as for non-aircraft applications. Thus, while the illustrated example show an interactive production illustration for supplier tooling processes for the main landing gear door of an aircraft, the various embodiments may be used in other applications. It should be noted that the interactive production illustration information may be initially accessed and selected as described in more detail herein. It also should be noted that the various embodiments may provide the information in different formats or using different protocols as desired or needed.

For example, the interactive production illustration system 24 may be configured to allow access to and provide users 22 with assembly sequence information that is targeted on a particular area and/or that addresses a particular assembly process. It should be noted that the assembly sequence information may be customized for display, such as based on a particular application. FIG. 3 illustrates a main screen or user interface, which in this embodiment is a roadmap screen 70 that may be displayed to the user 22, such as via the monitor 33 of the machine vision system 30 (shown in FIG. 1). As used herein, when reference is made to a particular screen, this may be any type of displayable user interface or user interface screen, which may include, for example, graphics and/or text that are viewable and/or selectable by the user 22. For example, one or more the graphics and/or text may be configured as selection elements that are selectable by a user, such as using one or user controls or actions as described herein. In some embodiments, a heads up display may be provided that has built in “Eye Tracking” software” that supports “hands free” liberated mechanics as described in more detail herein.

In the illustrated embodiment, the roadmap screen 70 is a main interface for accessing information related to a particular set of interactive production illustrations, which in this embodiment is for the main landing gear doors of a 747 aircraft. The roadmap screen 70 is configured in various embodiments as a common reference point or interface for navigating through information related to the set of interactive production illustrations. In particular, the roadmap screen includes an aircraft graphic 72 that illustrates a portion of an aircraft and that includes one or more sub-areas 74 that are separately identified and selectable. It should be noted that each of the sub-areas 74 may include identifying text 76 (e.g., engineering drawing base numbers) to facilitate quicker identification of the sub-areas 74, which in this embodiment correspond to parts or portion of the aircraft. Once a user 24 selects a sub-area 74, the sub-area 74a is highlighted (e.g., colored) to identify the area as a target area. In various embodiments, additional targets 78 may be identified that correspond to the selected sub-area 74a, which may be linked to the sub-area 74a. For example, in the illustrated embodiment, the additional targets 78 may includes surrounding structure targets and door perimeter targets.

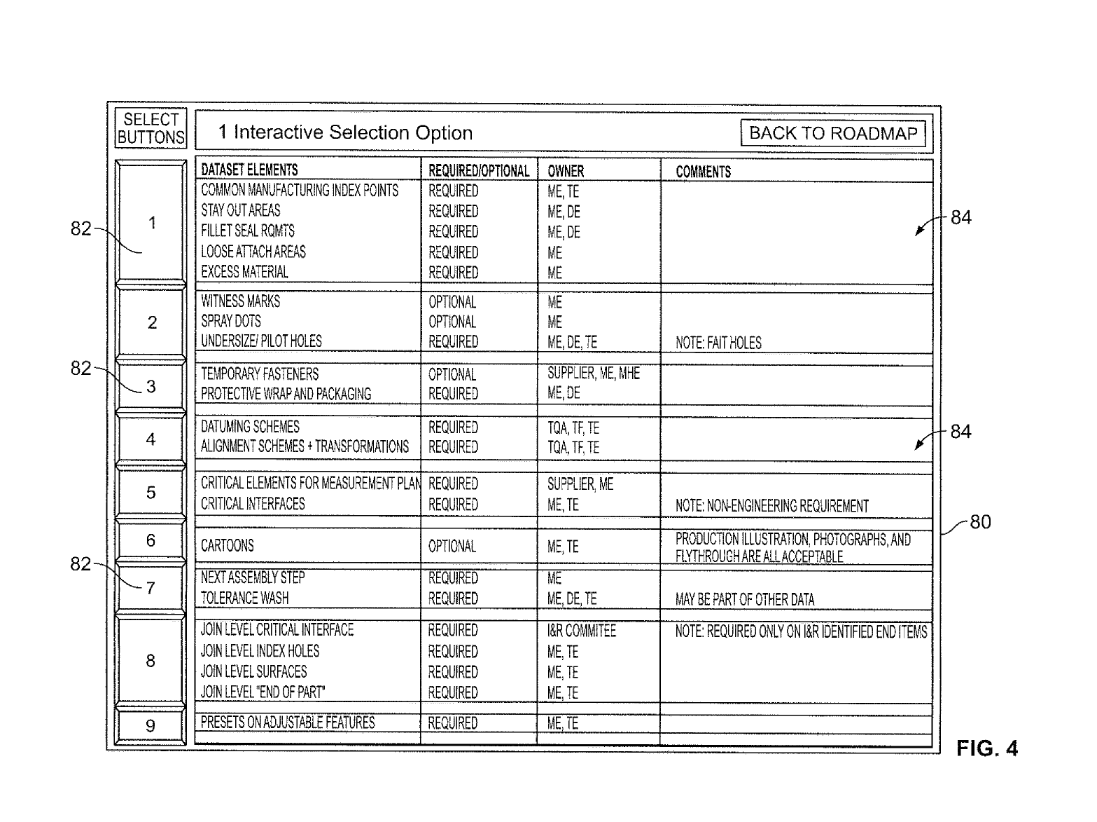

Once a user 22 selects the sub-area 74, an interactive selection screen 80 is displayed as shown in FIG. 4. For example, the interactive selection screen 80 may be displayed to allow a use to select from a plurality of different options corresponding to different interactive production illustrations related to the sub-area 74. For example, a plurality of user selectable element 82 (illustrated as numbered option buttons) may be displayed along a portion of the interactive selection screen 80 and having a corresponding list 84 describing or defining the information that may be accessed by selecting a particular one of the user selectable elements 82.

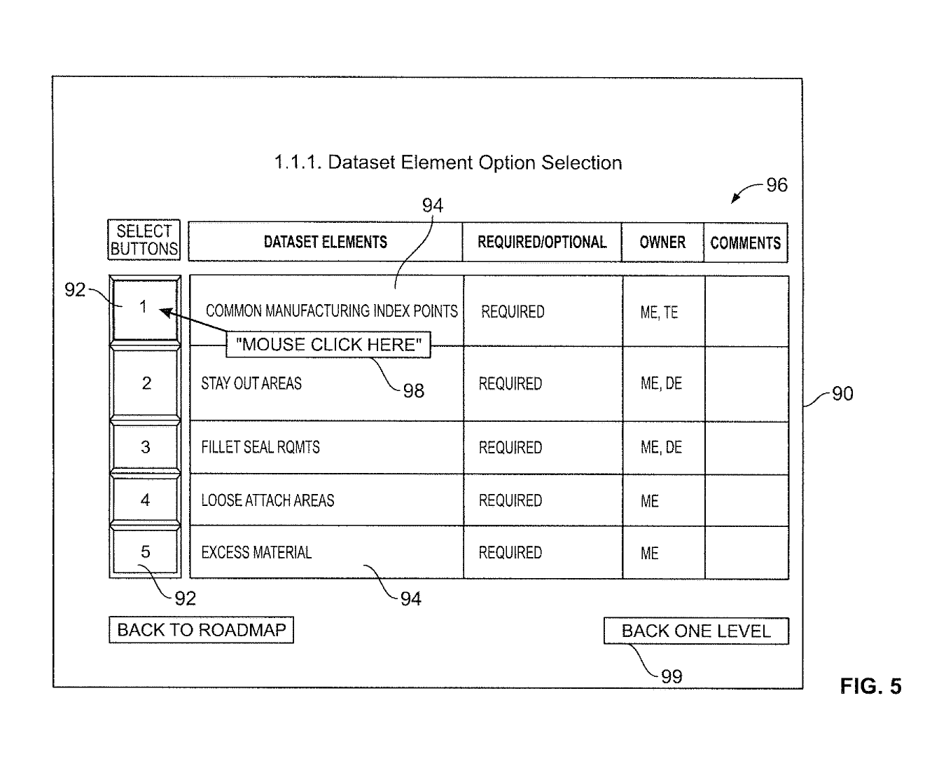

Upon selecting one of the user selectable elements 82, in various embodiments, a dataset element option selection screen 90 is displayed as shown in FIG. 5. In this example, a user has selected the user selectable element 82 numbered “1” which then displays the options only for that selection with a plurality of user selectable elements 92 now displayed and corresponding to each of a plurality of dataset elements 94. It should be noted that similar to the screen 80, the dataset elements 94 and corresponding description or supplemental information 96 whether the element is a required or optional action, the owner that is responsible for that elements and comments, among others) are displayed as a list. However, it should be appreciated that the information may be displayed in different formats, such as in charts, tables, etc. Additionally, instruction text 98 may be displayed to facilitate user interaction (e.g., text indicating to “click here”). Also, additional user selectable elements 99 may be provided, such as to return to the roadmap screen 70 (shown in FIG. 3) or to go back one level, which then displays the previously displayed screen.

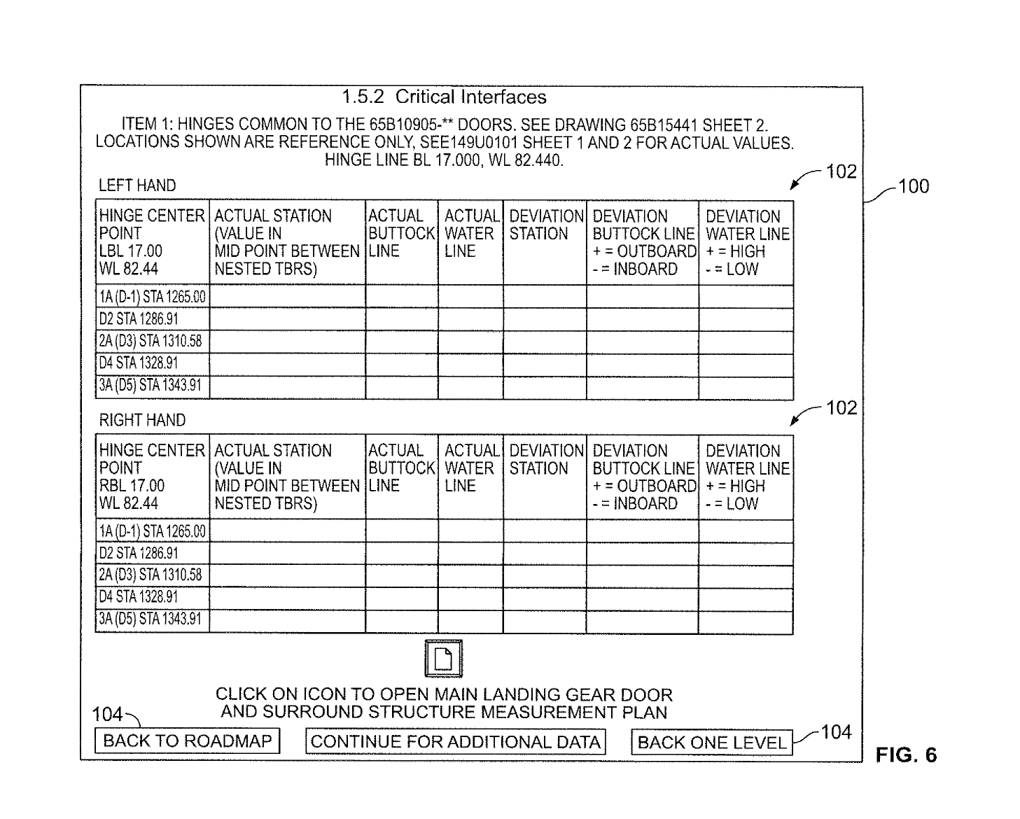

Additionally, various embodiments also may provide a production illustration data screen 100 as shown in FIG. 5, which may be accessed and in this embodiment is a Critical Interfaces element that was selected by the user 22. The element description screen 100 displays information 102 (shown as tables) providing the information specific to the selected element, such as part descriptions and identifying other supplemental information. Also, additional user selectable elements 104 may be provided, such as to return to the roadmap screen 70 (shown in FIG. 3) or to go back one level, which then displays the previously displayed screen. Also, in the element description screen 100 a user selectable element 106 is also displayed and is a hyperlink icon in this example, which would allow access to and display of additional information (e.g., additional publications). Thus, with reference to FIGS. 5 and 6, the dataset element option selections are divided into specific dataset elements, wherein data relating to the elements may be viewed by selecting the user selectable element 92.

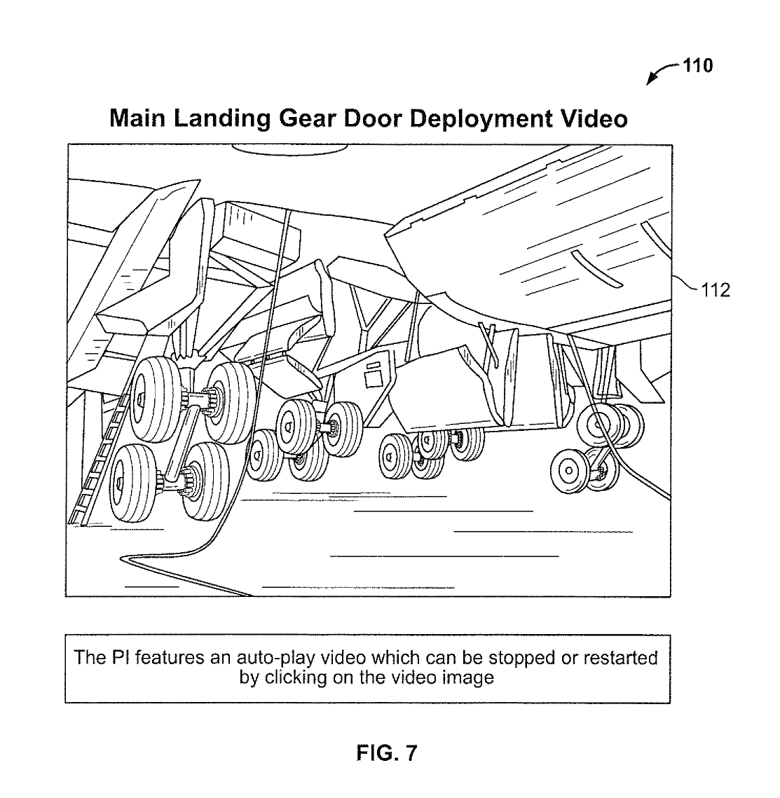

In some embodiments, additional content, such as video content may be accessed and displayed. For example, by selecting the user selectable element 106, a link to a video display 110 as shown in FIG. 7 may be provided. In this mode the user 22 is able to view a related video, which is illustrated as a main landing gear door deployment video, which may be auto-played and can be, for example, stopped, reversed, and/or restarted by selecting the video image 112. It should be noted that the video content of the video display 110 may provide different types of information. For example, the video display 110 may provide information or shown the operation of a particular part of the aircraft or may be, for example, an instruction video regarding how to perform a particular assembly sequence. In various embodiments, thus, real time problem solving may be provided. It should further be noted that different video content and information, for example, regarding different aspects of the aircraft may be provided. For example, some other videos may include, but are not limited to, a wing tank sensor protective cover loading video and/or a safety cover loading and unloading video (which stops accidental triggering of the passenger door escape slide, blowing out the side of the under construction aircraft).

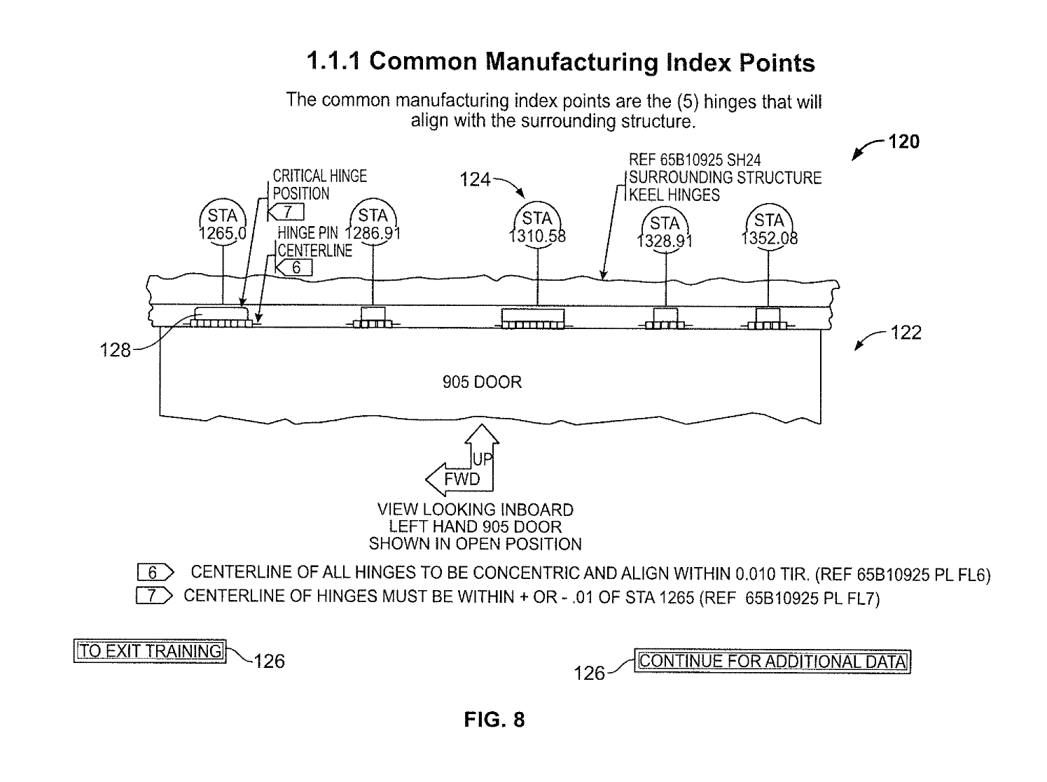

Referring again to FIG. 5, upon selecting one of the user selectable elements 92, an element description screen may be displayed. For example, in the illustrated embodiment, if the user selectable element 92 numbered “1” is selected, a corresponding information screen 120 is displayed as shown in FIG. 8, which displays common manufacturing index points information in this example. The information screen 120 includes specific information relating to the selected dataset element, which in this embodiment includes an illustration (which may be an interactive production illustration) having an image 122 of the part of interest (shown as a door) and corresponding text 124 (e.g., providing information and identifying common manufacturing index points as hinges that align with the surrounding structure). If supplemental information is available, such as a video or other publications (e.g., industry publications), a user electable element may be displayed to access such information. Also, additional user selectable elements 126 may be provided, such as to return to the roadmap screen 70 (shown in FIG. 3) or to go back one level, which then displays the previously displayed screen.

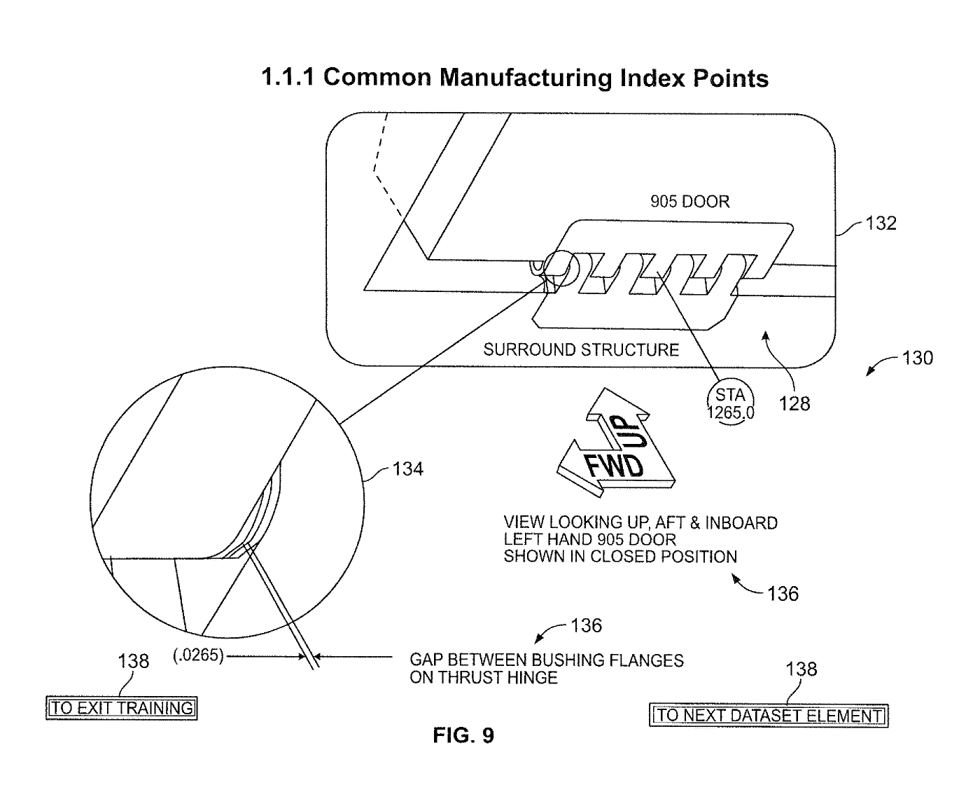

Additionally, if a user 22 selects a portion of the illustration, for example, the hinge element 128, an illustration screen 130 as shown in FIG. 9 may be displayed (or optionally or alternatively a video screen may be displayed as described herein). It should be noted that regions of the illustration that are selectable to access additional information may be identified, such as by highlighting or when a user places a pointer or cursor over that portion. As can be seen, the illustration screen 130 provides more detailed information regarding that portion of the part, which in the illustrated embodiment includes an image showing the hinge element 128 in more detail (perspective view) as well as a magnified portion 134 (exploded image) of a region of interest (in this embodiment an end structure of the hinge element 128). As can be seen, text 136 and other information are provided to facilitate performing the assembly step. Also, additional user selectable elements 138 may be provided, such as to exit the illustration screen 130 (e.g., exit the training) or move on to the next dataset element.

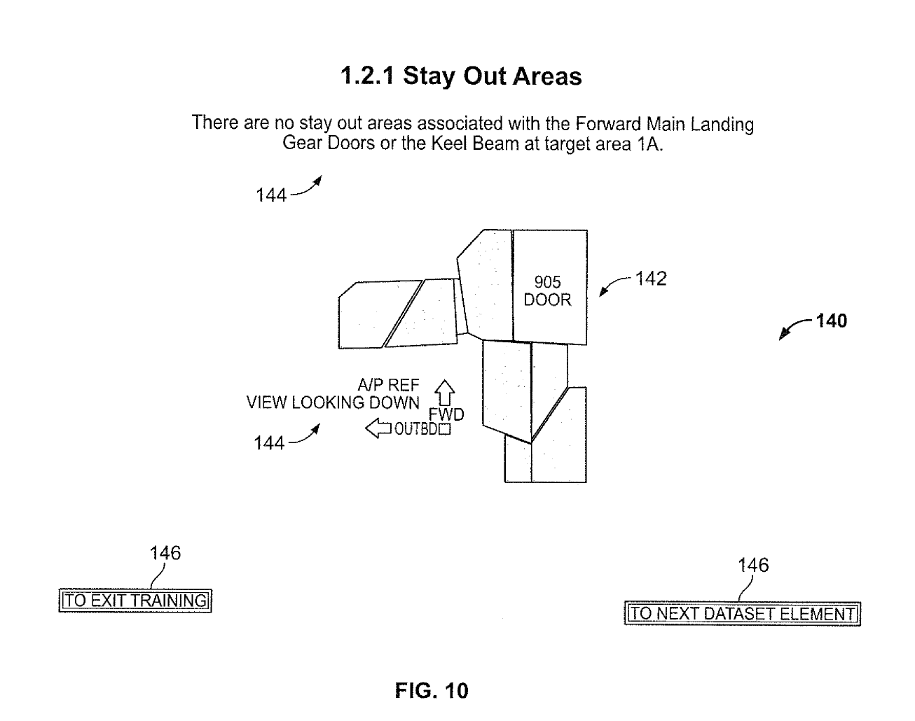

For example, in this embodiment, if the user selects the “To Next Dataset Element” user selectable element 138 or returns to the dataset element option selection screen 90 shown in FIG. 5 and selects another one of the user selectable elements 92 (continuing with this example is the “2” button), an information screen 140 as shown in FIG. 10 is displayed. Thus, in this example, the information screen 140 displays stay out areas information. The information screen 140 includes specific information relating to the selected dataset element, which in this embodiment includes an illustration (which may be an interactive production illustration) having an image 142 of the part of interest (shown as a door) and corresponding text 144 (e.g., providing information such as directional or alignment information and/or notes or comments regarding this assembly process). If supplemental information is available, such as a video or other publications (e.g., industry publications), a user electable element may be displayed to access such information.

Additionally, if a user 22 selects a portion of the illustration, an illustration screen may be displayed (or optionally or alternatively a video screen may be displayed as described herein) such as similar to the illustration screen 130 of FIG. 9 showing details regarding a particular portion of the part. It should be noted that regions of the illustration that are selectable to access additional information may be identified, such as by highlighting or when a user places a pointer or cursor over that portion. Also, additional user selectable elements 146 may be provided, such as to exit the information screen 140 (e.g., exit the training) or move on to the next dataset element.

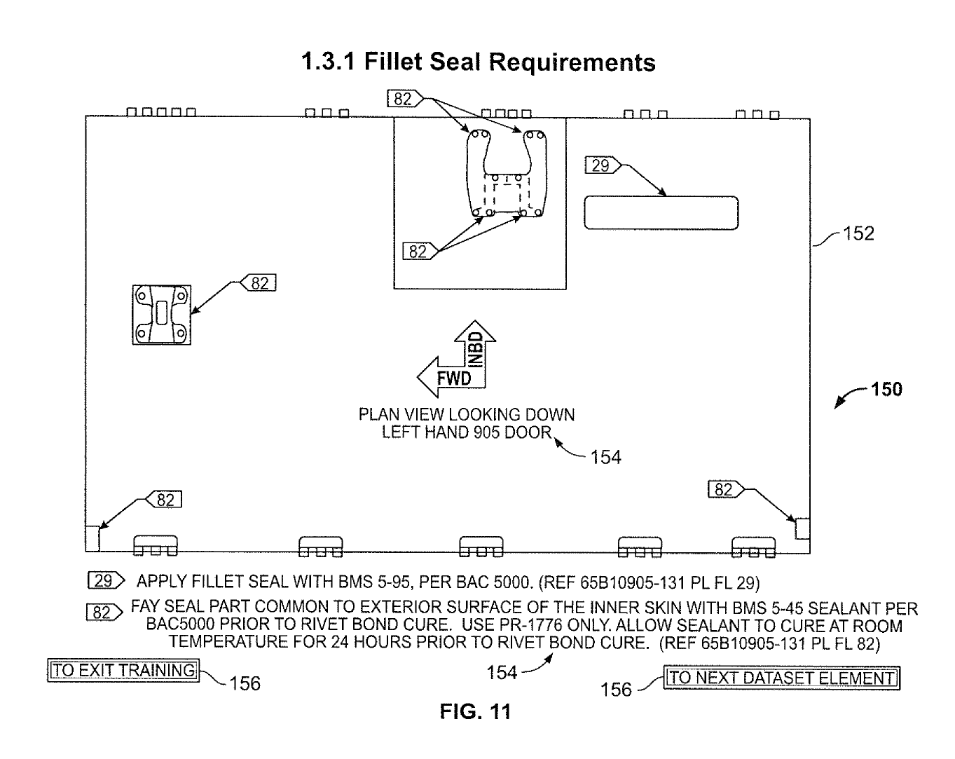

For example, in this embodiment, if the user selects the “To Next Dataset Element” user selectable element 146 or returns to the dataset element option selection screen 90 shown in FIG. 5 and selects another one of the user selectable elements 92 (continuing with this example is the “3” button), an information screen 150 as shown in FIG. 11 is displayed. Thus, in this example, the information screen 150 displays fillet seal requirements information. The information screen 150 includes specific information relating to the selected dataset element, which in this embodiment includes an illustration (which may be an interactive production illustration) that includes an image 152 of the part of interest (shown as a left hand door) and corresponding text 154 (e.g., providing information such as directional or alignment information and/or notes or comments regarding this assembly process). If supplemental information is available, such as a video or other publications (e.g., industry publications), a user electable element may be displayed to access such information.

Additionally, if a user 22 selects a portion of the illustration, an illustration screen may be displayed (or optionally or alternatively a video screen may be displayed as described herein) such as similar to the illustration screen 130 of FIG. 9 showing details regarding a particular portion of the part. It should be noted that regions of the illustration that are selectable to access additional information may be identified, such as by highlighting or when a user places a pointer or cursor over that portion. Also, additional user selectable elements 156 may be provided, such as to exit the information screen 150 (e.g., exit the training) or move on to the next dataset element.

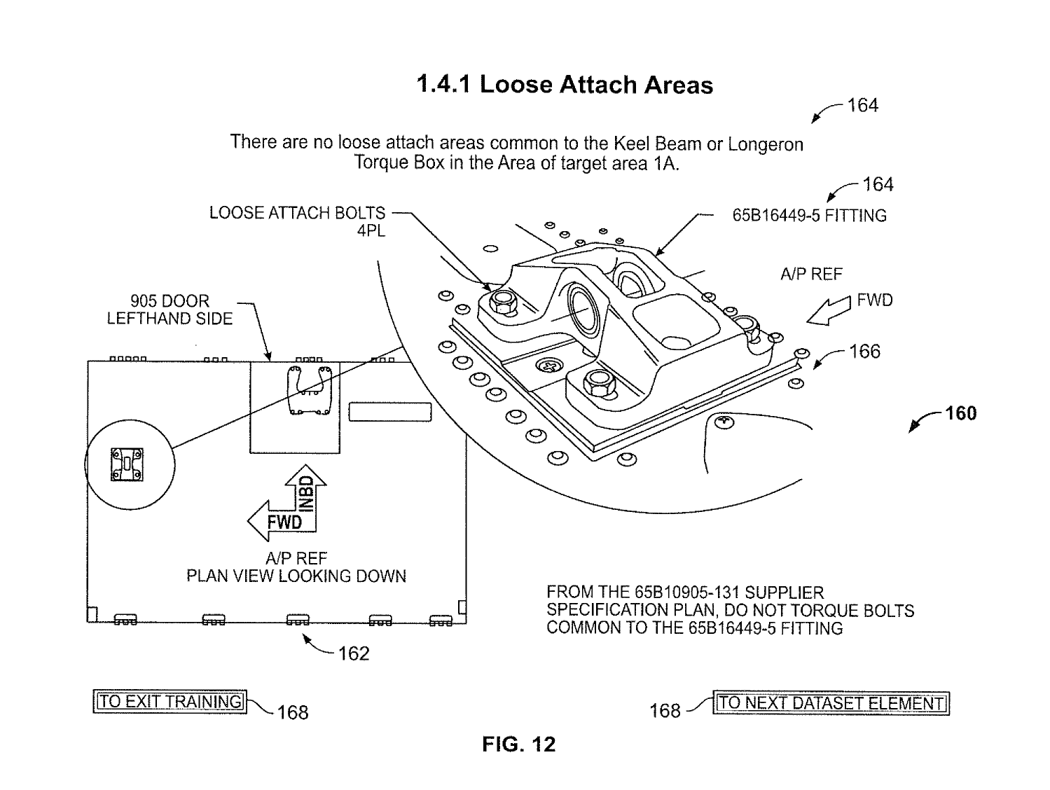

For example, in this embodiment, if the user selects the “To Next Dataset Element” user selectable element 156 or returns to the dataset element option selection screen 90 shown in FIG. 5 and selects another one of the user selectable elements 92 (continuing with this example is the “4” button), an information screen 160 as shown in FIG. 12 is displayed. Thus, in this example, the information screen 160 displays loose attach areas information. The information screen 160 includes specific information relating to the selected dataset element, which in this embodiment includes an illustration (which may be an interactive production illustration) that includes an image 162 of the part of interest (shown as a left hand side door) and corresponding text 154 (e.g., providing information such as directional or alignment information and/or notes or comments regarding this assembly process). In this embodiment, an enlarged or magnified and more detailed image 166 is also displayed (instead of on a separate illustration screen). If supplemental information is available, such as a video or other publications (e.g., industry publications), a user electable element may be displayed to access such information.

Additionally, if a user 22 selects a portion of the illustration, an illustration screen may be displayed (or optionally or alternatively a video screen may be displayed as described herein) such as similar to the illustration screen 130 of FIG. 9 showing details regarding a particular portion of the part. It should be noted that regions of the illustration that are selectable to access additional information may be identified, such as by highlighting or when a user places a pointer or cursor over that portion. For example, a heads up display may be provided that has built in “Eye Tracking” software” used to make selections. Also, additional user selectable elements 168 may be provided, such as to exit the information screen 160 (e.g., exit the training) or move on to the next dataset element.

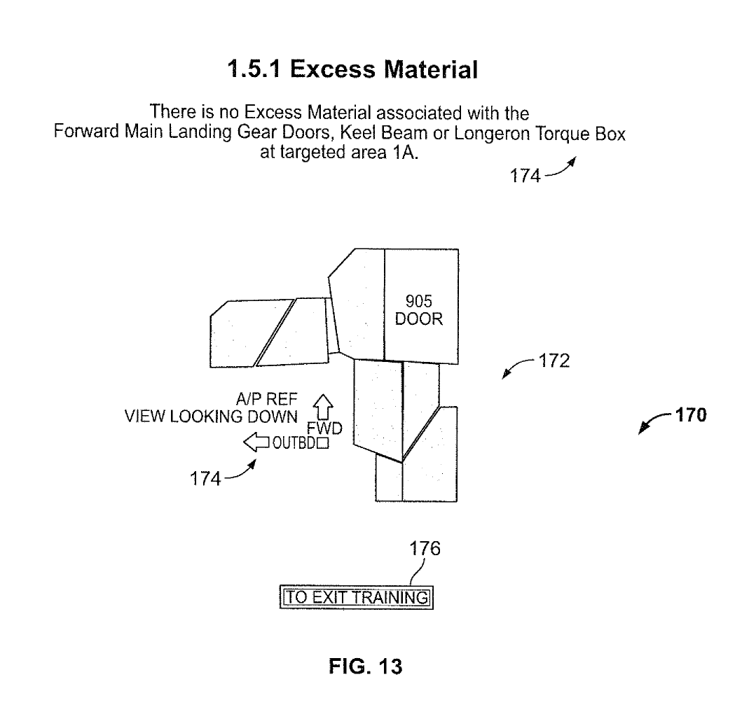

For example, in this embodiment, if the user selects the “To Next Dataset Element” user selectable element 168 or returns to the dataset element option selection screen 90 shown in FIG. 5 and selects another one of the user selectable elements 92 (continuing with this example is the “5” button), an information screen 170 as shown in FIG. 13 is displayed. Thus, in this example, the information screen 170 displays excess material information. The information screen 170 includes specific information relating to the selected dataset element, which in this embodiment includes an illustration (which may be an interactive production illustration) that includes an image 172 of the part of interest (shown as a door) and corresponding text 174 (e.g., providing information such as directional or alignment information and/or notes or comments regarding this assembly process). If supplemental information is available, such as a video or other publications (e.g., industry publications), a user electable element may be displayed to access such information.

Additionally, if a user 22 selects a portion of the illustration, an illustration screen may be displayed (or optionally or alternatively a video screen may be displayed as described herein) such as similar to the illustration screen 130 of FIG. 9 showing details regarding a particular portion of the part. It should be noted that regions of the illustration that are selectable to access additional information may be identified, such as by highlighting or when a user places a pointer or cursor over that portion. Also, additional user selectable elements, such as the user selectable element 176 may be provided, such as to exit the information screen 170 (e.g., exit the training) and return to the roadmap screen 70 (shown in FIG. 3).

It should be noted that the user 22 may navigate through the different user interfaces and screens on-site with the machine vision system 30 in some embodiments. However, in other embodiments, the interactive production illustration system 24 may be accessed using other means, including, for example, a separate workstation or computer on-site. As should be appreciated, other suitable interfaces with different types of user inputs may be provided to access the interactive production illustration system 24, such as known in the art. Additionally, the user input devices 38 (shown in FIG. 1) may be used to access the interactive production illustration system 24 at the location of the interactive production illustration system 24 and the information displayed on the display subsystem 40 (shown in FIG. 1).

Additionally, the information accessed using the interactive production illustration system 24 may include interactive production illustration information as described in more detail herein. However, other information may be accessed, such as industry information, company specific information, and recorded information, such as acquired by the machine vision system 30, among other information.

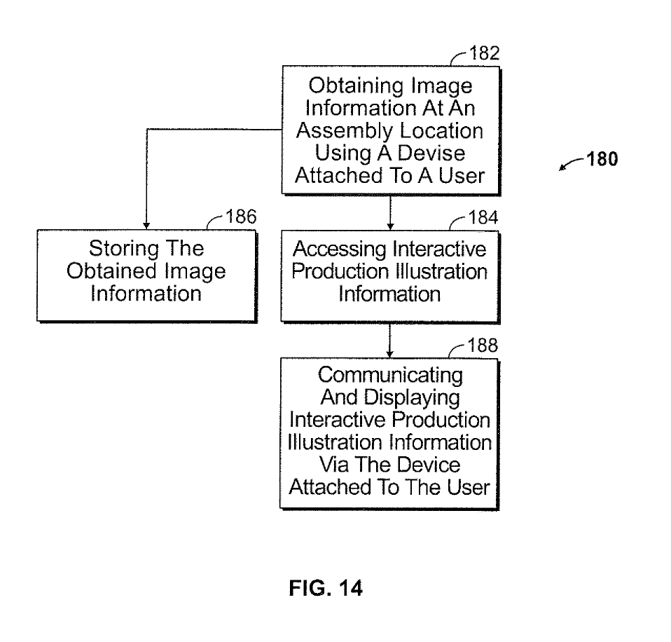

Various embodiments provide a method 180 as shown in FIG. 14 for providing interactive production illustration information. For example, the method 180 may provide pre-packaged intelligence for simplified aircraft assembly, which may include production and assembly linked to live, easy access, graphic support. The method 180, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 80 may be able to be used as one or more algorithms to direct hardware to perform operations described herein.

The method 180 includes obtaining image information at an assembly location at 182 using a device attached to a user. For example, image information from a field of view of the machine vision system 30 (shown in FIG. 1) attached to the user 22 may be acquired, such as still or video images in the line of sight of the user 22. The method also includes accessing interactive production illustration information at 184. For example, the user 22 may desire or need additional information in order to complete or properly perform the assembly process and performs a physical action (e.g., pressing a button on the machine vision system 30, performing some movement of the user's head or eyes) that causes the machine vision system 30 to access the interactive production illustration system 24 as described herein. It should be noted that the obtained information, such as the still or video images, may be stored at 186 as described herein.

In various embodiments, as a result of the user action, different types of information may be acquired as described herein. For example, interactive production illustration information, such as assembly sequence information may be acquired (e.g., video data associated with the assembly sequence) and communicated and displayed at 188 via the device attached to the user. The user may be able to then view and control the display of the video using video control procedures as described herein. In some embodiments, a heads up display is provided that has built in “Eye Tracking” software” that supports “hands free” liberated mechanics. For example, the left eye will move a “virtual” mouse cross hair, to the targeted part. Then with a Blink, the mechanic is clicking on the needed data ale. Voice commands via, for example, “Smart Dragon” software will also make aircraft assembly gathering quick and simple. Thus, in various embodiments, the mechanic's eye position will move the virtually visible Cross Hair. Then when the cross hair is touching the required or desired aircraft part image, the mechanic's “blink” will cause a “click” response.

Thus, various embodiments provide interactive production illustrations, for example, assembly sequence information and videos (e.g., video feeds) that may be communicated to the user (in real-time) from a remote location in various embodiments.

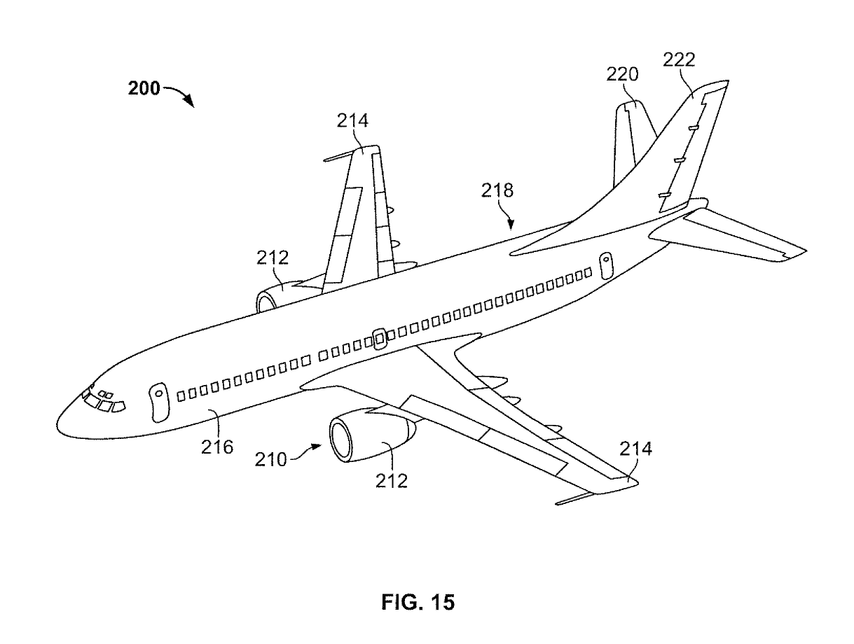

Various embodiments may be used, for example, in the assembly process of different types of air vehicles, such as commercial aircraft. For example, FIG. 15 illustrates an aircraft 200 that may include parts assembled using one or more embodiments. The aircraft 200 includes a propulsion system 210 that includes two turbofan engines 212. The engines 212 are carried by the wings 214 of the aircraft 200. In other embodiments, the engines 212 may be carried by a fuselage 216 (e.g., body of the aircraft 200) and/or the empennage 218. The empennage 218 can also support horizontal stabilizers 220 and a vertical stabilizer 222.

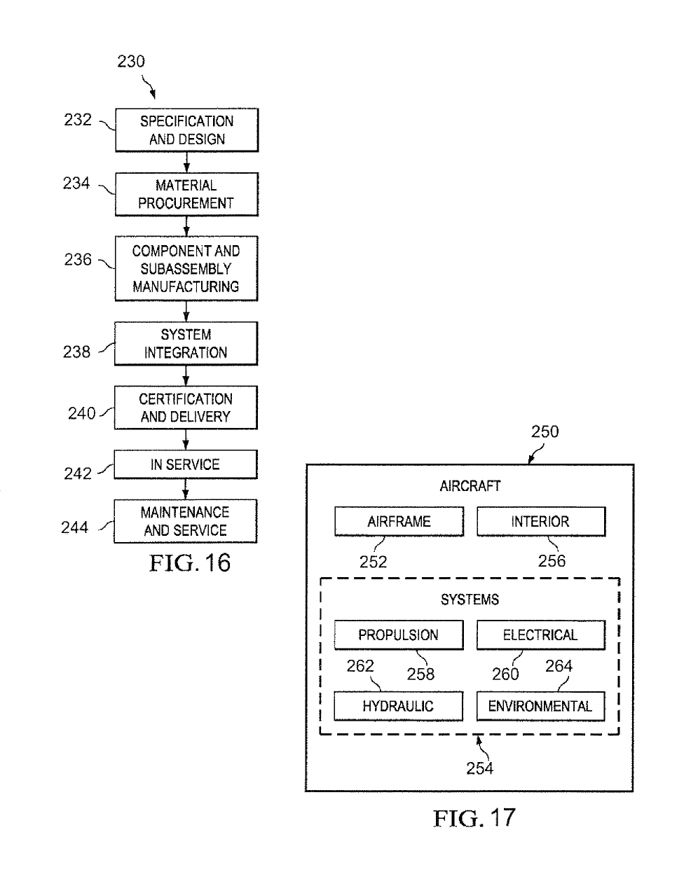

FIG. 16 is a flowchart of an aircraft manufacturing and service method 230 in accordance with an embodiment and FIG. 17 is an illustration of an aircraft in which or in connection with which various embodiments may be implemented. With reference to FIG. 16, during pre-production, the method 230 may include specification and design 232 of the aircraft 250 in FIG. 17 and material procurement 234. During production, component and subassembly manufacturing 236 and system integration 238 of the aircraft 250 in FIG. 17 takes place. Thereafter, the aircraft 250 of FIG. 17 may go through certification and delivery 240 in order to be placed in service 242. While in service by a customer, the aircraft 250 of FIG. 17 is scheduled for routine maintenance and service 244, which may include modification, reconfiguration, refurbishment, and other maintenance or service.

Each of the processes of aircraft manufacturing and service method 230 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, number of venders, subcontractors, and suppliers; and an operator may be an airline, leasing company, military entity, service organization, and so on.

With reference now to FIG. 17, an illustration of the aircraft 250 is depicted that is produced by the aircraft manufacturing and service method 230 in FIG. 16 and may include an airframe 252 with a plurality of systems 254 and an interior 256. Examples of the systems 254 include one or more of a propulsion system 258, an electrical system 260, a hydraulic system 262, and an environmental system 264. Any number of other systems may be included, Although an aerospace example is shown, different embodiments may be applied to other industries, such as the automotive industry.

Apparatus and methods embodied herein may be employed during any one or more of the stages of the aircraft manufacturing and service method 230 in FIG. 16. For example, components or subassemblies produced in component and subassembly manufacturing 236 in FIG. 1 may be fabricated or manufactured in a manner similar to components or subassemblies produced while the aircraft 250 of FIG. 17 is in service 242 in FIG. 16.

Also, one or more apparatus embodiments, method embodiments, or a combination thereof may be utilized during production stages, such as component and subassembly manufacturing 236 and system integration 238 in FIG. 16, for example, without limitation, by substantially expediting the assembly of or reducing the cost of the aircraft 250. Similarly, one or more of apparatus embodiments, method embodiments, or a combination thereof may be utilized while aircraft 250 is in service 242 or during maintenance and service 244 in FIG. 16.

As a specific example, one or more of the different embodiments may be implemented in component and subassembly manufacturing 236 to produce parts for the aircraft 250. Additionally, one or more embodiments also may be employed during maintenance and service 244 to fabricate parts for the aircraft 250. These parts may be replacement parts and/or upgrade parts.

It should be noted that the particular arrangement of components (e.g., the number, types, placement, or the like) of the illustrated embodiments may be modified in various alternate embodiments. In various embodiments, different numbers of a given module or unit may be employed, a different type or types of a given module or unit may be employed, a number of modules or units (or aspects thereof) may be combined, a given module or unit may be divided into plural modules (or sub-modules) or units (or sub-units), a given module or unit may be added, or a given module or unit may be omitted.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical drive, and the like. The storage device may also be other similar means for loading computer programs or other instructions into the computer or processor.

As used herein, the term “computer,” “controller,” and “module” may each include any processor-based or microprocessor-based system including systems using microcontrollers, reduced instruction set computers (RISC), application specific integrated circuits (ASICs), logic circuits, CPUs, FPGAs, and any other circuit or processor capable of executing the functions described herein. The above examples are exemplary only, and are thus not intended to limit in any way the definition and/or meaning of the term “module” or “computer.”

The computer, module, or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer, module, or processor as a processing machine to perform specific operations such as the methods and processes of the various embodiments described and/or illustrated herein. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program. The individual components of the various embodiments may be virtualized and hosted by a cloud type computational environment, for example to allow for dynamic allocation of computational power, without requiring the user concerning the location, configuration, and/or specific hardware of the computer system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein,” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed:

1. A system comprising:
a machine vision system configured to attach to a user, the machine vision system when attached to the user aligned with a line of sight of the user towards a physical location, the machine vision system controllable by the user and configured to acquire an image of an article at the physical location based on a physical action of the user; and
an interactive production illustration system commutatively coupled to the machine vision system, the interactive production illustration system storing interactive production illustration information accessible by the machine vision system, the interactive production illustration system configured to select interactive production illustration information for an assembly process for the article at the physical location based at least in part on the acquired image, the interactive production illustration information further configured to communicate the selected interactive production illustration information to the machine vision system for display.

2. The system of claim 1, wherein the interactive production illustration information comprises assembly sequence information for assembling at least a portion of the article.

3. The system of claim 1, wherein the interactive production illustration information is video data showing one of an operation or assembly sequence related to at least a portion of the article.

4. The system of claim 1, wherein the machine vision system comprises a head mounted display for viewing the interactive production illustration information.

5. The system of claim 1, wherein the interactive production illustration system comprises a computing system having a logic subsystem configured to analyze the acquired image from the machine vision system to select interactive production illustration information for display.

6. The system of claim 1, wherein the interactive production illustration system comprises a storage subsystem configured to store the acquired image from the machine vision system.

7. The system of claim 1, wherein the machine vision system is configured to acquire a plurality of images of an assembly sequence performed by the user on the article and the interactive production illustration system comprises a storage subsystem configured to store the plurality of images.

8. The system of claim 1, wherein the interactive production illustration information comprises a plurality of interactive user interface screens displayable by the machine vision system.

9. The system of claim 8, wherein the plurality of interactive user interface screens include interactive selectable elements to access one or more interactive production illustrations.

10. The system of claim 1, wherein the article is an aircraft and the interactive production illustration information comprises assembly sequence information for assembling at least a portion of the aircraft.

11. A method for accessing, by a user, an assembly sequence for an article, the method comprising:
disposing a machine vision system on a portion of the user, the machine vision system aligning with a line of sight of the user;
directing by the user, the line of sight towards a physical location of the article associated with the assembly sequence;
causing, via at least one physical action by the user, the machine vision system to acquire an image and thereby generate image data associated with the physical location;
accessing, based at least in part on the image data, interactive production illustration information, the interactive production illustration information associated with the assembly sequence for the article for the physical location; and
displaying the interactive production illustration information to the user.

12. The method of claim 11, wherein accessing the interactive production illustration information comprises accessing video data showing one of an operation or assembly sequence related to at least a portion of the article.

13. The method of claim 11, wherein disposing the machine vision system on a portion of the user comprises attaching a portion of the machine vision system to a head of the user, the machine vision system including an image recording device and a display for viewing the interactive production illustration information.

14. The method of claim 11, further comprising analyzing the acquired image from the machine vision system to select interactive production illustration information for display.

15. The method of claim 11, further comprising storing the acquired image from the machine vision system.

16. The method of claim 11, further comprising acquiring a plurality of images of an assembly sequence performed by the user on the article and storing the plurality of images.

17. The method of claim 11, wherein the article is an aircraft and accessing the interactive production illustration information comprises accessing user interface screens that include interactive selectable elements to access one or more interactive production illustrations that comprise assembly sequence information for assembling at least a portion of the aircraft.

18. A non-transitory computer readable storage medium for accessing interactive production illustration information using a processor, the non-transitory computer readable storage medium including instructions to command the processor to:
obtain from a machine vision system attached to a user an image of an article at a physical location, wherein the image is acquired based on a physical action of the user and the machine vision system when attached to the user is aligned with a line of sight of the user towards the physical location;
accessing stored interactive production illustration information;
selecting interactive production illustration information for an assembly process for the article at the physical location based at least in part on the acquired image; and
communicating the selected interactive production illustration information to the machine vision system for display.

19. The non-transitory computer readable storage medium of claim 18, wherein the instructions command the processor to analyze the acquired image from the machine vision system to select interactive production illustration information for display.

20. The non-transitory computer readable storage medium of claim 18, wherein the instructions command the processor to store the acquired image from the machine vision system.

21. The non-transitory computer readable storage medium of claim 18, wherein the article is an aircraft and the interactive production illustration information comprises a plurality of interactive user interface screens and the instructions command the processor to communicate for display by the machine vision system one or more of the plurality of interactive user interface screens, the plurality of interactive user interface screens including interactive selectable elements to access one or more interactive production illustrations for an assembly sequence for assembling at least a portion of the aircraft.
